(19) United States
(12) Patent Application Publication
(10) Pub. No.: US 2023/0377172 A1
(43) Pub. Date: Nov. 23, 2023

(54) OBJECT AUTOMATIC TRACKING SYSTEM AND IDENTIFICATION METHOD THEREOF

(71) Applicant: FENG CHIA UNIVERSITY, Taichung City (TW)

(72) Inventor: KUAN-HUNG CHEN, Taichung City (TW)

(21) Appl. No.: 18/080,726

(22) Filed: Dec. 13, 2022

(30) Foreign Application Priority Data
May 18, 2022 (TW) 111118455

(51) Int. Cl. G06T 7/246; G06V 20/50; G06V 10/77

(52) U.S. Cl. CPC G06T 7/246; G06V 20/50; G06V 10/7715; G06T 2207/30241; G06T 2207/20084

(57) ABSTRACT

The present invention provides an object automatic tracking system, which includes an image capturing device, a computing device and a display device, and the computing device includes a first computing module and a second computing module. The captured-in image is converted into a frame data and determined as either the first data or the second data according to the type of each frame. The first data is to obtain a property information and a location information of each target object in the image; and the second data is to obtain the trajectory information of each target object. Finally, the property information, the location information and the trajectory information are combined and output to the display device.

### TECHNICAL FIELD

The present invention provides an object automatic tracking system and an identification method, which may be executed in the small-sized edge computing device.

### BACKGROUND OF RELATED ARTS

Nowadays, object identification technology is widely applied in different fields. Thereinafter, compare with general robots, mobile robots such as guide robots, dish delivery robots, and dish-receiving robots which are suitable for convenience stores, hotels, and restaurants are needed to have the ability to identify dynamic obstacles in real-time.

However, based on the consideration of cost and applicable environment, most of mobile robots cannot actually carry a computing device with high computing ability.

Therefore, an object automatic identification system and an identification method thereof capable of performing high-precision computing on a small-sized edge computing device are indeed the inventions expected by present industry.

### SUMMARY

As the above description, the present invention relates to an automatic object tracking system and an identification method thereof.

An object automatic tracking system according to an embodiment of the present invention includes an image capturing device, a computing device and a display device, and the computing device includes a first computing module and a second computing module. The image capturing device is connected to the computing device for acquiring and transmitting an image to the computing device for processing. Further, the computing device is connected to the display device to display the final processing result on the display device.

In some embodiments, the above-mentioned first computing module includes: a first portion, a second portion, and a detecting structure. Furthermore, the first portion includes a plurality of convolution sets and a plurality of residual blocks, which are used for performing feature extraction on the inputted first data, and to output a plurality of initial feature maps correspondingly. The second portion is connected to the first portion, and the second portion is used for concatenating the initial feature maps from the first portion, and correspondingly outputting at least one feature map. The detecting structure is connected to the second portion for detecting the feature maps outputted from the second portion, and generating a property information and a location information of each target object appearing in the origin input image.

An identification method of an automatic object tracking system according to an embodiment of the present invention includes the following steps: At the beginning an image is captured by the automatic object tracking system described above. The image is converted into a frame data by using an MPEG encoding format, and determined as either the first data or the second data according to the type of each frame in the frame data. On the other hand, the above-mentioned first computing module is used for performing operation on the first data to obtain a property information and a location information of each target object in the image. At the same time, the above-mentioned second computing module is used for processing the second data to obtain the trajectory information of each target object. Finally, the property information, the location information and the trajectory information are combined and output to the above-mentioned display device.

The above-mentioned descriptions are only preferred embodiments of the present invention and are not intended to limit the scope of implementation of the present invention. Therefore, all the shapes, structures, features, and spirits described in the scope of the patent application of the present invention shall be regarded as equivalent to the changes and modifications per se, and be included in the scope of the patent application of the present invention.

### BRIEF DESCRIPTION OF THE DRAWINGS

FIG. 1 is a schematic diagram of the system structure of an embodiment of the object automatic tracking system of the present invention.

FIG. 2 is a schematic diagram of the first computing module of the embodiment of the object automatic tracking system of the present invention.

FIG. 3 is a flow chart of the method of the embodiment of the object automatic tracking system of the present invention

### DETAILED DESCRIPTION OF THE INVENTION

The present invention relates to an object automatic tracking system, which may be executed in the small-sized edge computing device.

Thereinafter, to make the description of the present disclosure more detailed and complete, the following description provides an illustrative description for the implementation and specific embodiments of the present invention. However, the following description is not the only form of implementing or using specific embodiments of the invention. In these paragraphs, the features of various specific embodiments are covered as well as the method steps and sequences for constructing and operating these specific embodiments. However, the other embodiments may also be utilized to achieve the same or equivalent function and sequence of steps.

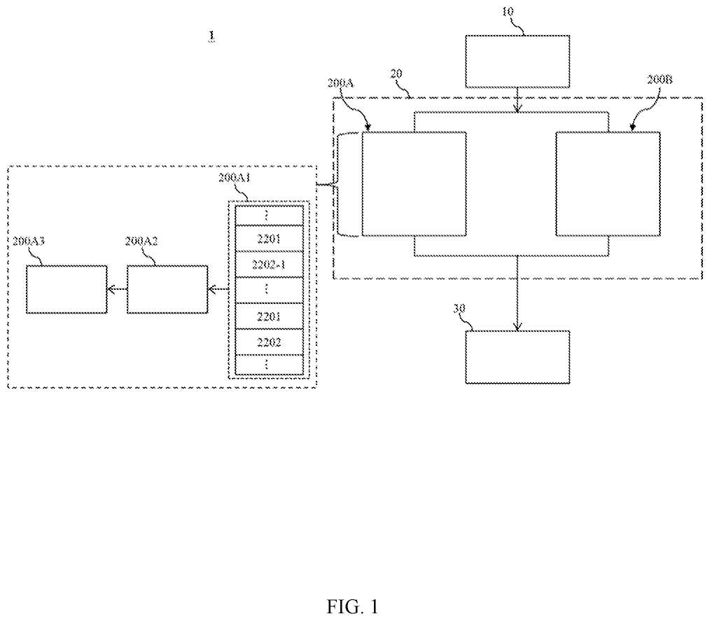

FIG. 1 is a schematic diagram of the object automatic tracking system of the present invention. In the embodiment. The object automatic tracking system 1 of the present invention is applied to mobile robot. The object automatic tracking system 1 include an image capturing device 10, a computing device 20, and a display device 30. The computing device 20 includes a first computing module 200A and a second computing module 200B. The image capturing device 10 is connected to the computing device 20 for transferring original capturing images to be processed by the computing device 20. Furthermore, the computing device 20 is connected to the display device 30, displaying the result on the display device 30. The abovementioned mobile robot included robots with mobility needs, such as house robot, factory robot, or service robot, etc.

In the embodiment, the object automatic tracking system 1 encoded the original capturing images to a frame data, and determines a first data or a second data which are calculated by the first computing module 200A and the second computing module 200B via the frame data type respectively. It significantly reduces the processing computations and executes the processing at a minimum speed of 30 fps (frames per second) in small-sized edge computing device, in the embodiment the small-sized edge computing device is AI edge computing platform such as NVDIA Jetson Nano™, Jetson Xavier NX™, etc.

Moreover, a group of frame data is a video frame by MPEG encoding format, a group of frame data includes at least one I frame (Intra frame) as the first data, and at least one P frame (Predicted frame) as the second data. The computing device 20 determined the type of the frame data. If the frame data is determined to be I frame, the frame data will be read and transferred to the first computing module 200A. Otherwise, if the frame data is detected as a P frame, the frame data will be read and transferred to the second computing module 200B. Furthermore, the frame data is a video frame that is encoded with GOP (Group of Picture) structure, the first data is a collection of I frame in GOP structure, and the second data is a collection of P frame in GOP structure.

As shown in FIG. 1, the first computing module 200A is a neural network based on convolution algorithm. The convolution algorithm can be an algorithm that combines Deep Neural Network (DNN), Recurrent Neural Network (RNN), Convolution Neural Network (CNN), You Only Look Once (YOLO), Reinforcement Learning (RL) or the algorithm formed under one or more abovementioned convolution algorithm (s). The first computing module 200A comprises a first portion 200A1, a second portion 200A2, and a detecting structure 200A3. In the present embodiment, the first portion 200A1 is connected to the second portion 200A2 and the first portion 200A1 transmits these initial feature maps with different sizes to the second portion 200A2. The second portion 200A2 concatenate these initial feature maps to be a feature map with an area equal to the product of length and width. The second portion 200A2 transmits the feature map to the detecting structure 200A3 for object identification. The detecting structure 200A3 classified and locate the target objects on every feature map. The detecting structure 200A3 get the information of the property and location of the target objects. In the embodiment, the scaling size of the above feature map is assumed to be three, and these three feature maps are with different lengths and widths, that are 13×13, 26×26, 52×52.

Specifically, in the first computing module 200A, the function of the first portion 200A1 is to perform feature extraction on the target object in the first data. The process of the second portion 200A2 concatenates local features between feature maps of different sizes.

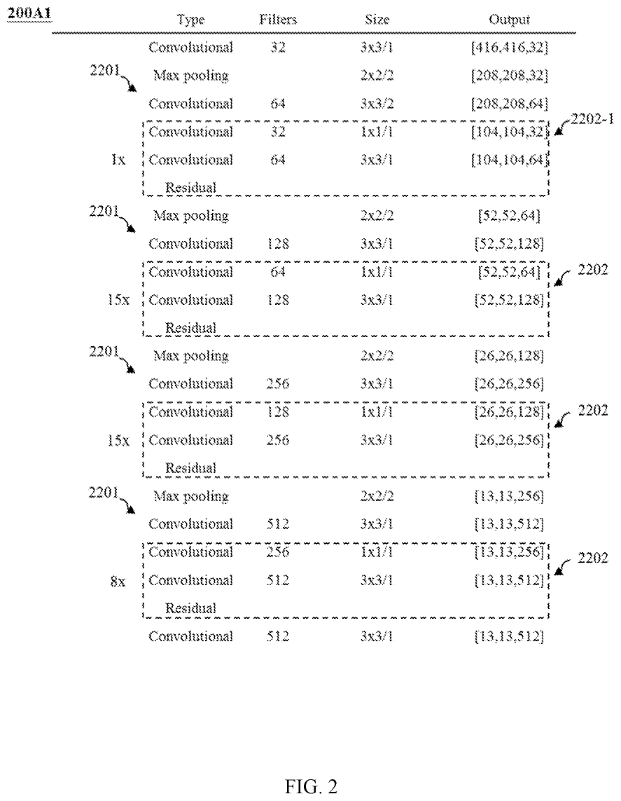

In the embodiment, the first portion 200A1 includes a plurality of convolution sets 2201 and a plurality of residual blocks 2202. As shown in FIG. 2, these convolution sets 2201 positioned between any two residual blocks 2202 and positioned before the first residual block (residual block 2202-1 shown in FIG. 2) The convolution sets 2201 densely connected with the residual blocks 2202. Every convolution set 2201 comprises at least one convolutional and at least one max pooling. In the plurality of convolution sets 2201, the stride of the pooling layer which is connected to the first residual blocks is 2. In addition, in the embodiment, the first residual block 2202-1 represents the deepest residual block in the first portion 200A1.

In the embodiment, the convolutions included in each residual block 2202 of the first computing module 200A are connected to each other. In addition, the overall computation of the neural network is directly correlated to the number of convolutional layers included in the densely connected convolution sets 2201 in each residual block 2202 and the number of filters used in each residual block 2202, and inversely correlated to the number of max pooling or convolution stride.

Based on the above reasons, the user can reduce the overall neural network complexity by increasing the amount of the max pooling or increasing the convolution stride of the first computing module. That can improve the execution speed of the first computing module 200A on a small-sized edge computing device. At the same time, on the other hand, increasing the number of residual blocks 2202 used, or increasing the filter types to increase the number of neurons in the network can improve the detection accuracy (for example, the user can set the amount of the residual blocks in the first portion 200A1 to 1, 15, 15, 8, and can set the filter type to 32, 64, 128, 256, and 512). Thus, it is ensured that the edge computing device can maintain a detection accuracy above a certain level on the basis of high execution speed.

Furthermore, in the embodiment, the network complexity can be future reduced to achieve the effect of speeding up network convergence by setting the convolution of second portion 200A2 to the spatial separable convolution.

Please further refer to FIG. 1, the second computing module 200B executes a target tracking algorithm to predict the object trajectory. In the embodiment, the target tracking algorithm may be one of Kalman Filter, particle filter, or mean-shift. And the target tracking algorithm is updated by using Intersection Over Union (IOU) matching or cascade matching. Furthermore, a convolutional neural network (CNNs) can be used for performing a similarity calculation on the tracking results, and the similarity calculation can be based on cosine distance, Euclidean distance, Manhattan distance, Chebyshev distance, Minkowski distance, Mahalanobis distance or other distance measurement methods.

The second computing module 200B adopted one of the above target tracking algorithms and predicted the trajectory of each target object in the second data, and obtained a trajectory information corresponding to the target object.

FIG. 2 is a schematic diagram of the first computing module 200A of the above embodiments for the object automatic tracking system presented in this invention. In the embodiment, the first computing module 200A has 39 layers and four convolution units. Specifically, every convolution unit includes a convolution set 2201 and a repeatedly executed residual block 2202, in which the so-called repeated execution represents that each residual block 2202 is executed respectively the actions once, 15 times, 15 times, and 8 times in the four convolution units.

Specifically, as shown in FIG. 2, the convolutional in every residual block 2202 is composed of 3×3 (with stride 1) convolutional and 1×1 (with stride 1) convolutional. In each convolution set 2201, all convolutional is with size 3×3 but with different stride sizes. Except for the convolutional which connected to the first residual block 2202-1 is with stride 2, other convolutionals are all with stride 1, the max pooling is with size 2×2 (with stride 2).

In this way, the first computing module 200A of the present embodiment can dramatically decrease the computing amount by inserting more max pooling and changing the stride of the convolutional which connected to the first residual block 2202-1 in the convolution sets 2201 to a larger size such as two. It is also possible to further increase the number of layers of the first computing module 200A to increase the amount of parameter for each convolution process, thereby achieving high detection accuracy while maintaining high execution speed (for example: AP is 90.58% based on VOC2007 test).

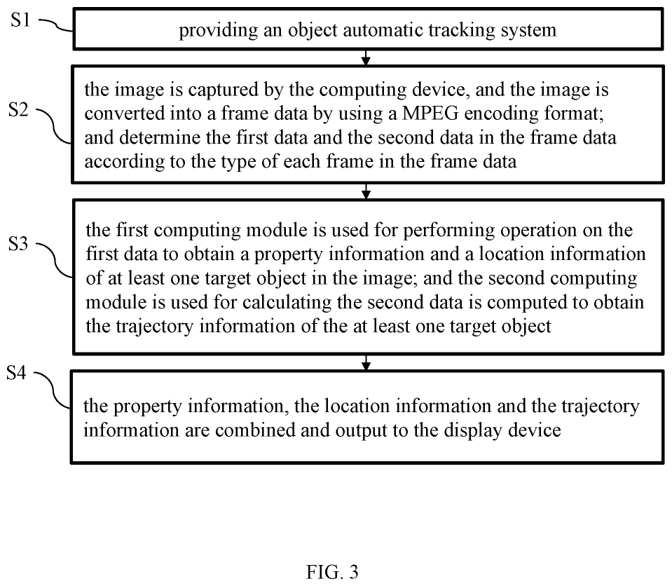

FIG. 3 is a flow chart of the method for the embodiment of the object automatic tracking system in the present invention. The method is performed by the object automatic tracking system 1 of FIG. 1 (S1), and includes at least the following steps:

In the beginning, in step 2, an original image is obtained from image capturing device 10 and transmitted to the computing device 20, and then the computing device converts the original image into a group of frame data using a MPEG encoding format, and determines the image as either the first data or the second data according to the type of each frame in the frame data. In the embodiment, the above MPEG encoding format is based on group of picture (GOP), at the same time, the first data is an I frame in the frame data, and the second data is a P frame in the frame data.

In the next step S3, the computing device 20 performs computation for the first data by the first computing module 200A, thus to obtain property information and location information corresponding to each target object in the origin input image; at the same time, the second computing module 200B is used for processing the second data, thus to obtain the trajectory information corresponding to each target object in the origin input image.

Finally, in step S4, the computing device 20 combines and outputs the obtained category information, position information, and trajectory information to the display device 30 so as to be reflected on the original image. In this embodiment, the merging may be implemented by executing the Non-Maximum Suppression (NMS) algorithm, Soft-NMS algorithm or similar algorithms in the prior art, and details are not described herein again.

The above-mentioned descriptions are only preferred embodiments of the present invention and are not intended to limit the scope of implementation of the present invention. Therefore, all the shapes, structures, features, and spirits described in the scope of the patent application of the present invention shall be regarded as equivalent to the changes and modifications per se, and be included in the scope of the patent application of the present invention.

What is claimed is:

1. An object automatic tracking system, comprising:
an image capturing device, used for obtaining an image;
a computing device, connected with the image capturing device for receiving the image that captured by the image capturing device, and the computing device comprises a first computing module and a second computing module; and
a display device is connected to the computing device;
wherein the image is captured by the computing device, and the image is converted into a frame data by using a MPEG encoding format, and determined as either the first data or the second data according to the type of each frame in the frame data;
the first computing module is used for performing operation on the first data to obtain a property information and a location information of each target object in the image; and the second computing module is used for processing the second data to obtain the trajectory information of each target object; and the property information, the location information and the trajectory information are combined and output to the display device.

2. The object automatic tracking system as claimed in claim 1, wherein the MPEG encoding format is based on group of picture (GOP), and the type of the first data is I-frames, and the type of the second data is P-frames.

3. The object automatic tracking system as claimed in claim 1, wherein the first computing module comprises:
a first portion comprised a plurality of convolution sets and a plurality of residual blocks, and used for extracting the features based on the first data, and outputting a plurality of initial feature maps, wherein every convolution set comprising at least one convolution and at least one max pooling;
a second portion is connected to the first portion, and is used for concatenating the plurality of initial feature maps and correspondingly outputting at least one feature map; and
a detecting structure is connected to the second portion, and used for detecting the feature map from the second portion, which consequently generates information of the property and location of each target object.

4. The object automatic tracking system as claimed in claim 3, wherein the stride of the convolutional layers connecting to the first residual blocks in the plurality of convolutional groups is 2.

5. The object automatic tracking system as claimed in claim 3, wherein the convolution sets are configured between any two residual blocks and configured before first residual block.

6. The object automatic tracking system as claimed in claim 1, wherein the second computing module adopted at least one target tracking algorithm.

7. A method for tracking an object automatically, comprise:
S1: providing the object automatic identification system as described in claim 1;
S2: the image is captured by the computing device, and the image is converted into a frame data by using a MPEG encoding format;
and determined as either the first data or the second data according to the type of each frame in the frame data;
S3: the first computing module is used for performing operation on the first data to obtain a property information and a location information of each target object in the image; and the second computing module is used for processing for the second data to obtain the trajectory information of each target object; and
S4: the property information, the location information and the trajectory information are combined and output to the display device.

8. The method as claimed in claim 7, wherein the MPEG encoding format is based on group of picture (GOP) encoding format, and the type of first data is I-frames, and the type of second data is P-frames.

9. The method as claimed in claim 7, wherein the computing device adopts the Non-Maximum Suppression (NMS) algorithm and the Soft-NMS algorithm to perform the merging of the classification information, the location information and the track information.
